(19) United States
(12) Patent Application Publication
(10) Pub. No.: US 2010/0327049 A1
(43) Pub. Date: Dec. 30, 2010

(54) COMPONENT PART COUNTING DEVICE AND METHOD OF USE THEREOF

(75) Inventor: Aditya Shetye, Syracuse, NY (US)

Correspondence Address: JOHN MEZZALINGUA ASSOCIATES, INC., C/O SCHMEISER OLSEN & WATTS, 22 CENTURY HILL DRIVE, SUITE 302, LATHAM, NY, 12110, US

(73) Assignee: John Mezzalingua Associates Inc., East Syracuse, NY (US)

(21) Appl. No.: 12/492,181

(22) Filed: Jun. 26, 2009

(51) Int. Cl. G06M 1/00

(52) U.S. Cl. 235/1 R

(57) ABSTRACT

Disclosed herein is a component part counting device including a tray and a known plurality of circular bores located on a face of the tray, each of the bores having a diameter and depth to receive a component, each of the bores having a diameter and depth to prevent more than one of the components from being received.

### FIELD OF THE INVENTION

The subject matter disclosed herein relates generally to counting devices. More particularly, this invention provides for a counting device for the counting of component parts and method of use thereof.

### BACKGROUND OF THE INVENTION

In the production of a variety of machined parts, it is often the case that the parts will need to be counted during and after one or more stages of machining. For example, machined component parts, such as grip rings, need to be counted before being sent out for plating. Once received for plating, it is often the unfortunate case that the count of the component parts at the plating stage does not match with the count that that was sent at the machining stage. Significant weekly positive and/or negative count variances between various machining stages are not uncommon. These count variances are commonly attributed to the very light weight of the parts, the frequency of part sampling at the scale, and human error in counting. Although parts are often counted by hand in an attempt to ensure accuracy, hand counting is frequently erroneous and is a time-consuming task.

Accordingly, a counting device for accurate and rapid counting of component parts, and a method of use thereof, would be well received in the art.

### BRIEF DESCRIPTION OF THE INVENTION

According to one aspect of the invention, a method of collecting a known plurality of components comprises providing a counting device, wherein the counting device includes a tray and a known plurality of circular bores located on a face of the tray, each of the circular bores having a diameter and depth to receive a component, each of the circular bores having a diameter and depth to prevent more than one of the components from being received. The method further comprises introducing an unknown plurality of the components onto the tray moving the tray such that the components fall into the circular bores until each of the circular bores includes one of the components and collecting a known plurality of the components from within the circular bores.

According to another aspect of the invention, a method of creating a counting device comprises measuring a standard dimension of a component part and establishing a plurality of reception pockets into a slab, the pockets each having a dimension slightly larger than the corresponding dimension of the component part such that only one component part fits into each of the plurality of reception pockets.

According to yet another aspect of the invention, a counting device comprises a tray and a known plurality of circular bores located on a face of the tray, each of the bores having a diameter and depth to receive a component, each of the bores having a diameter and depth to prevent more than one of the components from being received.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of a collecting device having tray with a known plurality of bores in accordance with one embodiment of the present invention;

FIG. 2 depicts top view of the counting device;

FIG. 3 depicts a side view of the counting device;

FIG. 4 depicts a perspective view of an embodiment of a grip ring component, dimensioned to fit within a bore of the counting device;

FIG. 5 depicts an embodiment of a slab after a plurality of bores 16 have been established thereon;

FIG. 6 depicts an embodiment of a counting device after an unknown plurality of the components have been poured onto the tray; and

FIG. 7 depicts an embodiment of a counting device after each of the bores includes a single of the grip ring components.

### DETAILED DESCRIPTION OF THE INVENTION

A detailed description of the hereinafter described embodiments of the disclosed apparatus and method are presented herein by way of exemplification and not limitation with reference to the Figures.

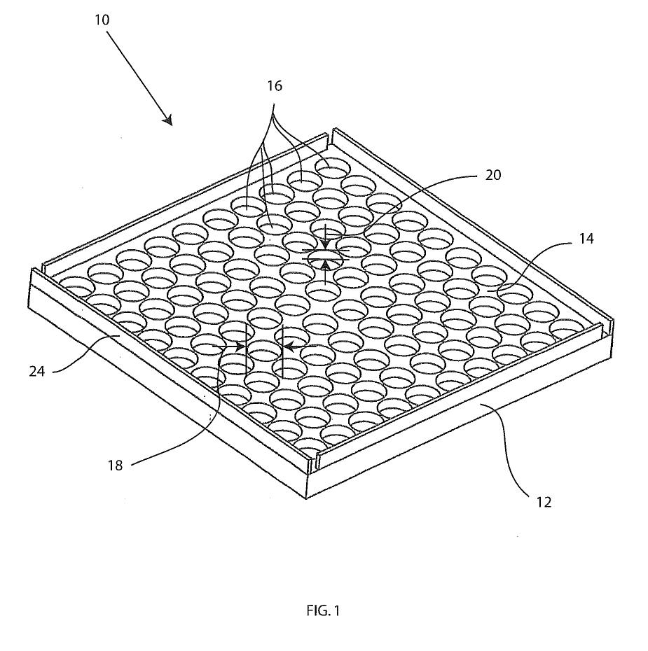

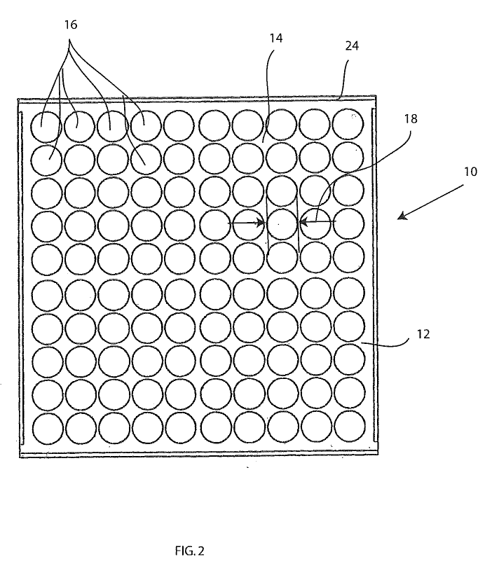

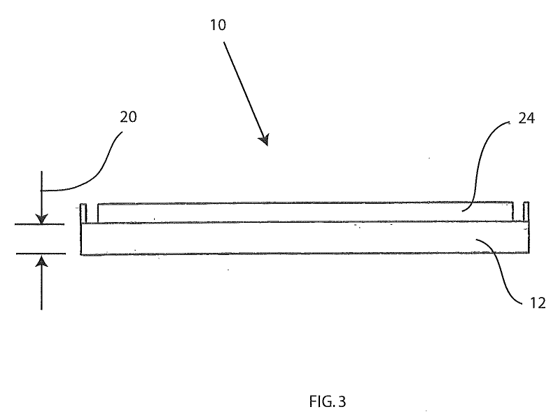

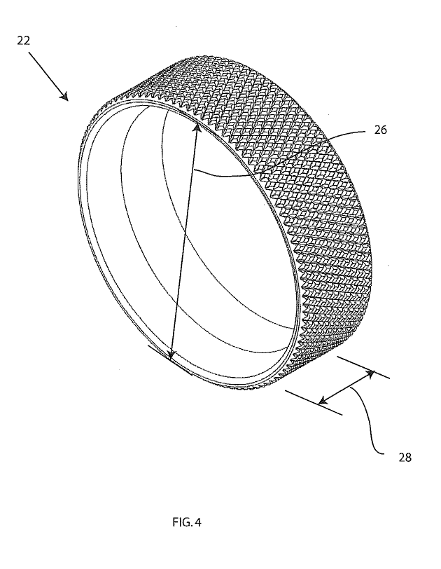

Referring to FIGS. 1-3, there is shown a counting device 10 in accordance with one embodiment of the present invention. Particularly, FIG. 1 shows a perspective view of the counting device 10, FIG. 2 depicts a top view of the counting device 10 and FIG. 3 depicts a side view of the counting device 10. The counting device 10 includes a tray 12. A face 14 of the tray 12 includes a known plurality of circular bores 16. Each of the circular bores 16 has a diameter 18 and a depth 20 to receive a single component, such as a grip ring 22 (shown in FIG. 4), but no more than one of the component 22. Each component 22 has a diameter and depth corresponding to the diameter 18 and depth 20 of the circular bores 16. To use the counting device 10, an unknown plurality of the components 22 are introduced onto the tray 12. The counting device 10 may then be shaken or otherwise moved such that the components 22 fall into the circular bores 16 until each circular bore 16 includes one of the components 22. To help facilitate correlative retention of the components 22 on the tray 12 during the movement or shaking of the counting device 10, a side retaining wall 24 is included around the perimeter of the tray 12. Thus, the counting device 10 may collect a known plurality of the components 22 equal to the known quantity of circular bores 16. It should be understood that the present invention is not limited to the counting device 10, but is also directed toward a method for creating the counting device 10, and a method of collecting a known plurality of components, as will be described herein below.

The component counting device 10 has several advantageous structural qualities that help facilitate appropriate setting or seating of the component parts 22 into the bores 16. For example, the counting device 10 may be sized for convenient handheld grip so a user may perform lateral sliding and shaking without difficulty. Thus, the counting device may have a width less than two feet long. Further, the side retaining wall 24 may have a height such that enough components are kept on the tray to allow them to be movably positioned into the bores 16. The side retaining wall 24 may also facilitate in allowing slight vertical agitation of the device to impel movement of the components 22 on and over the tray 12. The height of the retaining wall 24 may be small enough so that the counting device 10 is not bulky or overly heavy for a user. Thus, the side retaining walls 24 may be between 1 to 6 inches in height. The walls 24 may be at least half of the height of the components 22 being counted, so that the wall 24 may help to contain the components 22 to be counted on the counting device 10 during the counting operation. For instance, if a component 22 had a part height that was 2 inches, then the wall 24 height should be at least 1 inch. In addition, the wall 24 height need not be more than twice the height of the components 22 being counted, to thereby help facilitate dispersion of excess components 22 from off of the counting device 10 during the counting operation. Further, the pockets or bores 16 may be equidistant to contribute to the tendency of the components to settle therein. Each pocket or bore 16 may be neighboring a plurality of other bores 16 with very little spacing in between. Preferably, the spacing is less than 1 inch, and may be in the range of 1/32 to ⅛ of an inch. Furthermore, the depth of the pockets or bores 16 should be such that only one of the component parts 22 fits therein. The component part 22 should fit such that the top of the component part 22 is substantially level to the rest of the tray 12 so that other component parts 22 may slide over the bores 16 thereafter.

Referring still to FIGS. 1-3, the face 14 of the counting device 10 is shown with the tray 12 having a generally square shape. However, the tray 12 is not limited to this shape and may also be circular, triangular, hexagonal, octagonal, rectangular, asymmetrical, or the like. Furthermore, the tray 12 may be fashioned from any appropriate material such as wood, metal, plastic or ceramic. It should be understood that the assembled parts of the counting device 10 may or may not be fashioned from the same material. For example, the tray 12 may be made of a metal material such as steel while the side retaining wall 24 may be fashioned from wood.

The tray 12 is shown to include a known plurality of the circular bores 16. Particularly, one hundred of the circular bores 16 are located on the face 14 of the tray 12. The tray 12 includes ten rows, each row having ten of the circular bores 16 in it. In one embodiment, the diameter 18 and the depth 20 dimensions of the circular bores 16 allow for one of the components 22 to be received in each bore 16. However, the dimensions 18, 20 also prevent more than one of the components 22 from being received by each bore 16. The counting device 10 is not limited to this arrangement, however. For example, the bores 16 may have any appropriate shape corresponding to the shape of a component. For example, the bores 16 may be square, hexagonal, triangular, octagonal, rectangular, asymmetrical, or the like. It should be understood that the bores 16 may also be reception pockets, openings, gaps, holes, notches, apertures, cavities, breaches or the like, and may or may not be manufactured into the face 14 of the tray 12 with a boring process.

In one embodiment, the bores 16 are dimensioned to receive a grip ring 22, the grip ring 22 being shown in FIG. 4. The grip ring 22 may be screw machined and may be configured to fit with a cable connector, such as a coaxial cable connector (not shown). Furthermore, the grip ring 22 may have a diameter 26 and a length 28 that correspond with the diameter 18 and depth 20 of the circular bores 16 such that one grip ring 22 may snuggly fit into one circular bore 16. The size of the circular bores 16 may be proportional to the size of the parts that will settle into them. For instance the diameter 26 of a bore 16 should be just slightly larger than the diameter of a component part that will ultimately settle into the hole for counting, so that the slightly larger diameter 26 may accommodate clearance of the component part in settling into the bore 16. In one embodiment, the bores 16 may each have a diameter between ⅜ and ¾ inches to accommodate a typical grip ring having a substantially similar and slightly smaller diameter. Further, the bores 16 may each have a depth between ⅛ and ½ inches to accommodate one of the grip rings 22 having a substantially similar depth. Again, the depth 20 should not be more than the height of the part and may be somewhat less than the depth of the part. However, the depth 20 should not be less than half the depth of the part, so that settling of component parts into bores 16 may be efficiently facilitated. Because of the substantially similar dimensions, other grip rings 22 may be permitted to slide, without interference, across any bore 16 having a grip ring 22 already received therein.

It should be understood that the invention is not limited to counting and collection of grip rings; any other countable physical components are contemplated. For example, the component may be a hexagonal nut. In that case, the bores may also be hexagonal. Whatever the shape of the component, at least one standard dimension may be measured from that component. The standard dimension may be a diameter of a circular component, the length a side of a square component, the height of a cylindrical component, the curvature of a spherical component or any appropriate dimension describing the component part. Many component parts may have a plurality of standard dimensions. For example, a cylindrical component may have the standard dimensions of a diameter and a height. Whatever the appropriate standard dimensions for a particular component, the bores 16 should have a corresponding dimension that is slightly larger than the standard dimension, such that the particular component fits snugly therein.

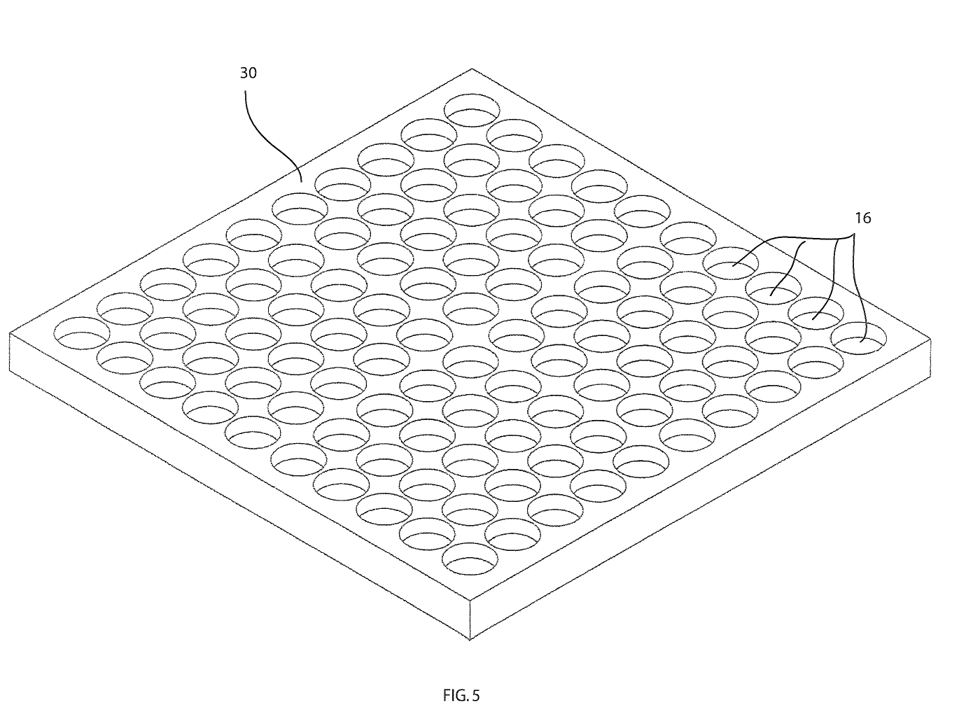

Another embodiment of the present invention includes a method of creating the collecting device 10. The method of creating the collecting device 10 includes first measuring at least one standard dimension of a component part. In the embodiment depicted in the Figures, the component part is the grip ring 22 and the standard dimensions may be either or both of the diameter 26 or the length 28. The method further includes establishing a plurality of reception pockets or bores 16 into a slab 30. FIG. 5 shows the slab 30 after the reception pockets or bores 16 have been established. The pockets or bores 16 are established such that each of the bores 16 has dimensions 32, 34 that are substantially similar to the corresponding standard dimensions 26, 28 of one of the grip rings 22. This allows one grip ring 22 to fit snugly into each of the plurality of reception pockets or bores 16. The method of establishing the bores 16 into the slab 30 may be a boring or drilling process. However, other processes may be using a mold to shape the slab 30. Alternately, the slab 30 may include holes, to which the reception pockets or bores 16 may be attached. It should be understood that fashioning the reception pockets or bores 16 into the slab 30 are not limited to these processes, but may be fashioned via any operable process known in the art.

The method of creating the collecting device 10 may further comprise locating each of the plurality of reception pockets or bores 16 equidistant from each other on the slab 30. In one embodiment, the method may also comprise locating the plurality of reception pockets or bores 16 on the slab 30 such that the pockets or bores 16 are arranged into a plurality of equispaced rows. For example, the reception pockets or bores 16 may be arranged into ten rows, each of the rows having ten pockets or bores 16, as depicted in the Figures. Finally, the method may comprise attaching the side retaining walls 24 to the perimeter of the slab 30. The retaining walls 24 may be attached with fasteners, such as screws or nails, or may be affixed by glue, epoxy, solder, weld, or any other bonding means. Other appropriate attachment means will be apparent to those skilled in the art.

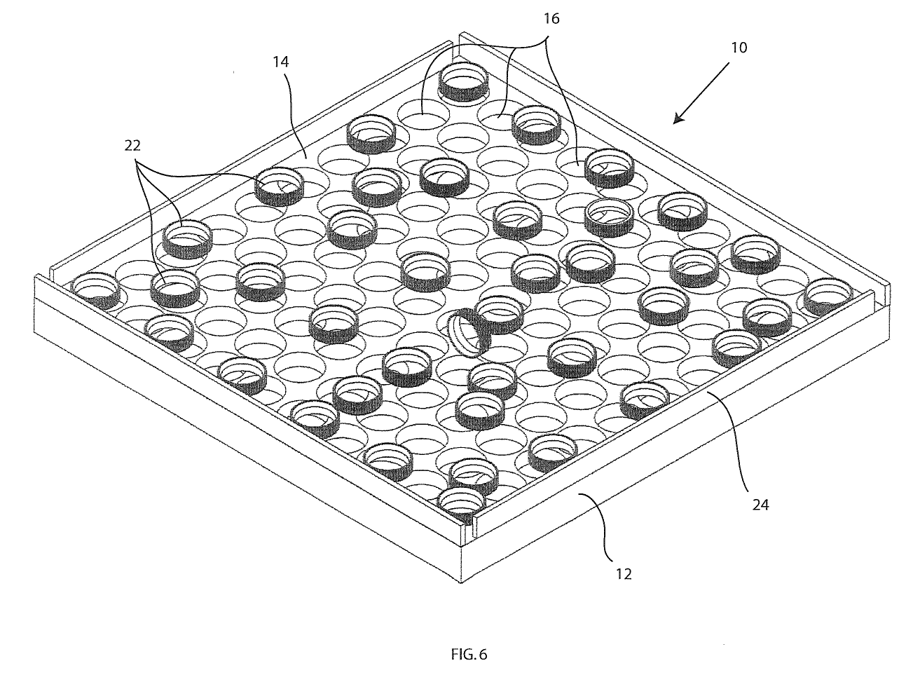

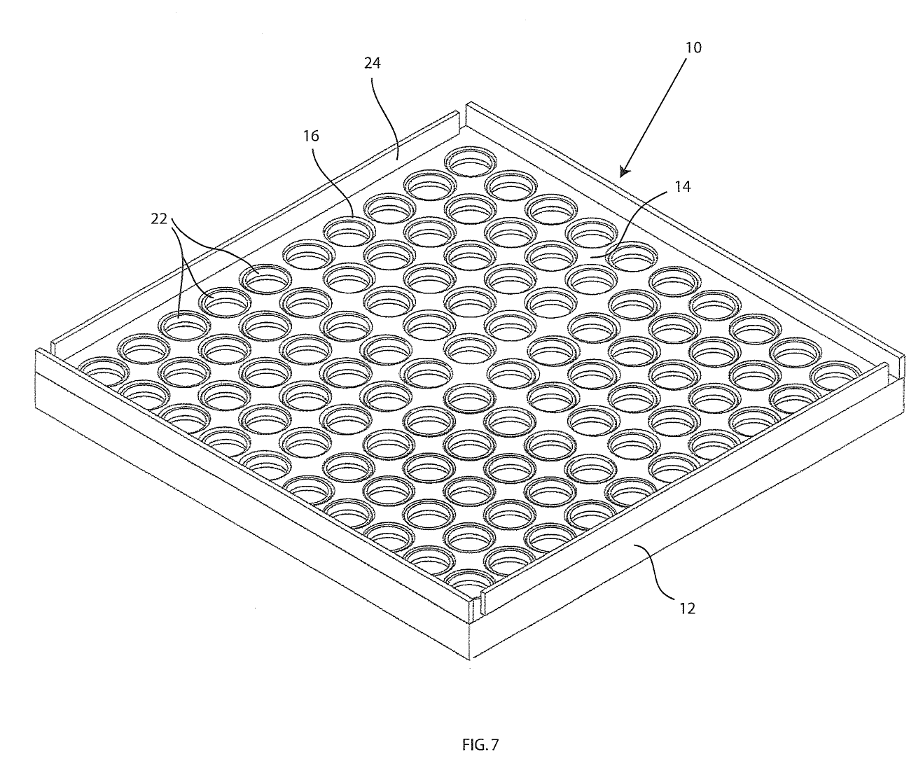

A further embodiment of the present invention includes a method of collecting a known plurality of the components 22. Steps of the method being used to sort grip ring components are shown in FIGS. 6 and 7. The method first includes providing the collecting device 10 including the tray 12 having a known plurality of bores 16, reception pockets or the like, as described hereinabove. Again, the bores 16 may be dimensioned to snugly receive a known plurality of the components 22, such as the grip rings. The method may further include introducing an unknown plurality of the components 22 onto the tray 12, as depicted in FIG. 6. The components 22 may be dumped onto the tray 12 by hand, for example, or may even be introduced by machine. Next, the tray may be moved such that the components 22 fall into the bores 16 until each of the bores 16 includes one of the components 22. This step of the method is shown in FIG. 7, which depicts a single grip ring component 22 in each of the circular bores 16. It should be understood that this step may be performed by an operator simply moving or shaking the tray 12. The tray 12 should not be shaken so much that grip ring components 22 are shaken out of the bores 16. Alternately, the counting device may be operably connected to a machine (not shown) that automatically performs the moving function. It should be recognized that if any of the bores 16 are empty, more of the components 22 may be introduced and the tray 12 shaken or moved another time. In other words, the method may take a single iteration or several iterations of introducing the components 22 and moving the tray 12 before each of the bores 16 contains one of the components 22. Furthermore, the method may include removing excess of the components 22 that were introduced onto the tray 12 that did not fall into one of the bores 16 after each of the bores 16 has received one of the components 22. Once each of the bores 16 include a snugly fit component 22 and the excess components have been removed, the method may further include collecting a known plurality of the components 22 from within the circular bores 16, the known plurality equal to the number of circular bores 16 on the tray 12. For example, the method may also comprise pouring the plurality of the components out of the tray 12 and to a collection location. The collection location may be a box, bag, or other such container. Alternately, the collection location may be a transporting machine. The parts may be stored or transported in the collection location to an appropriate area, such as a plating facility, or a packaging facility.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A method of collecting a known plurality of components comprising:
providing a counting device, wherein the counting device includes:
a tray; and
a known plurality of circular bores located on a face of the tray, each of the circular bores having a diameter and depth to receive a component, each of the circular bores having a diameter and depth to prevent more than one of the components from being received;
introducing an unknown plurality of the components onto the tray;
moving the tray such that the components fall into the circular bores until each of the circular bores includes one of the components; and
collecting a known plurality of the components from within the circular bores.

2. The method of claim 1, further comprising introducing more of the components after the moving the tray if any of the circular bores do not contain a component.

3. The method of claim 1, further comprising moving the tray a second time such that the more of the components fall into the circular bores.

4. The method of claim 1, further comprising removing excess of the components that did not fall into one of the circular bores after each of the circular bores receives one of the components.

5. The method of claim 1, wherein the component is a grip ring and the circular bores each have a diameter and depth to snuggly fit one grip ring.

6. The method of claim 1, further comprising pouring the known plurality of components out of the tray to a collected location.

7. A method of creating a counting device comprising:
measuring at least one standard dimension of a component part; and
establishing a plurality of reception pockets into a slab, the reception pockets each having a dimension substantially similar to the at least one standard dimension of the component part such that only one component part fits snugly into each of the plurality of reception pockets.

8. The method of creating a counting device of claim 7, further comprising establishing each of the plurality of reception pockets equidistant from each other on the slab.

9. The method of creating a counting device of claim 7, further comprising establishing the plurality of reception pockets on the slab such that the reception pockets are arranged into a plurality of equispaced rows.

10. The method of creating a counting device of claim 7, further comprising establishing one hundred reception pockets arranged into ten rows, each of the rows having ten reception pockets.

11. The method of creating a counting device of claim 7, further comprising attaching side retaining walls to the perimeter of the slab.

12. A component part counting device comprising:
a tray; and
a known plurality of circular bores located on a face of the tray, each of the bores having a diameter and depth to receive a component, each of the bores having a diameter and depth to prevent more than one of the components from being received.

13. The counting device of claim 12, wherein each of the bores has a diameter and depth to receive a grip ring, and wherein each of the bores has a diameter and depth to prevent more than one grip ring from being received.

14. The counting device of claim 12, wherein the counting device includes a wall around the perimeter of the tray.

15. The counting device of claim 12, wherein the number of circular bores located on the face of the tray is equal to one hundred.

16. The counting device of claim 15, wherein the tray includes ten rows of circular bores, each row comprising ten bores.

17. The counting device of claim 12, wherein the tray is square.

18. The counting device of claim 12, wherein the bores each have a diameter between ⅜ and ¾ inches.

19. The counting device of claim 12, wherein the bores each have a depth between ⅛ and ½ inches.

20. The counting device of claim 12, wherein the plurality of bores have an equidistant arrangement.
